(19) United States
(12) Patent Application Publication
(10) Pub. No.: US 2007/0061403 A1
(43) Pub. Date: Mar. 15, 2007

(54) Priority email alert system

(76) Inventor: Stephen Linden Seaburg, Traverse City, MI (US)

Correspondence Address: VERNON E. WILLIAMS P.C., P.O. BOX 941385, PLANO, TX, 75094, US

(21) Appl. No.: 11/228,797

(22) Filed: Sep. 15, 2005

(51) Int. Cl. G06F 15/16

(52) U.S. Cl. 709/206

(57) ABSTRACT

In accordance with the teachings of the present invention, a method and apparatus for providing a priority email alert is presented. Email is received in a mail server. Using a priority method, the email is identified as a priority email. The email is then forwarded using a telephone line or a radio frequency interface to an end user. Using the radio frequency interface the email is forwarded to a television or a portable wireless device. The television and/or portable wireless device is then operated to generate a visual or audible alert. The alert notifies the end user that a priority email is available for viewing.

### CROSS-REFERENCE TO RELATED APPLICATION

This application claims priority from provisional application Ser. No. ______ filed ______ and entitled Priority Email Alert System, which is hereby incorporated by reference in its entirety.

### BACKGROUND OF THE INVENTION

1. Field of the Invention

The present invention relates to email. Specifically, this invention relates to email alerting.

2. Description of the Prior Art:

Electronic mail or email is a form of communication in which electronic messages are communicated across the Internet from a sender to a receiver. A typical email includes a sender address and a receiver address. Based on the receiver address the email is routed across the network to the email recipient.

Conventional email has become so pervasive that a variety of mechanism have been devised to provide email recipients constant access to their email. Most of these devices and methods require some affirmative action on the part of the email recipient to identify that an email has arrived, such as operating a receiving device to check for an email. However, there are a wide variety of circumstances where it is not desirable for an email recipient to constantly check their email. Among these are during the evening when an email recipient is sleeping or when an email recipient is out in the yard and away from an email accessing device.

Thus, there is a need for a method and apparatus that facilitates access to email without an email recipients constant monitoring of an email-accessing device.

### SUMMARY OF THE INVENTION

In accordance with the teachings of the present invention, a system and method for alerting an end user of a priority email is presented. In one embodiment, an incoming email is received in a computer. The incoming email is identified as a priority email based on the sender address or based on a priority code (i.e., indicia). The incoming email is forwarded using a radio frequency (RF) communication link to a television, a set-top box connected to a television, a wireless portable device or a telephone. The television, wireless portable device, set-top box, and/or telephone is used to alert an enduser that a priority email has arrived.

In one embodiment, a system and method of providing an end user with a visual, audible, or vibration alert of a priority email message is presented. A priority email alert system enables an end user to be alerted (i.e., notified) by audible alert during the evening when the end user is sleeping. This is advantageous to business people receiving email from companies operating in different time zones. The end user will no longer have to stay awake and monitor the computer for important email but instead can go to sleep and be awakened by audible alert if and when a priority e-mail arrives.

In another embodiment a software system and method is presented in which a transmitter/receiver is attached to an end users computer. Using priority email alert software installed on the computer, the end user is able to list the email addresses they wish to be alerted (notified) to upon their arrival (i.e., new incoming email). The end user will also have the option of indicating how they would like to be alerted based on different alerting modes. The alerting modes include phone/fax, portable hand held receiver, or by television. The computer is then turned on and connected to the end users server to receive the priority email. In one embodiment, the priority email alert system uses a rolling code technology to enable operation when there are other receiver/transmitters communicating priority email, in close proximity.

In another embodiment, a system and method is presented where a portable wireless device notifies an end user of priority email using alerts. The alerts may be implemented using visual, audible or vibration techniques. When the end users computer receives a priority e-mail (i.e., email including a pre-identified address or indicia) a transmitter/receiver unit attached to the computer is activated and transmits an alert signal to a wireless portable device. The computer transmitter continuously sends the priority e-mail alert message until the wireless portable device acknowledges the received message and then returns a message back to the computer indicating that the end user has received the message.

In one embodiment, the end user can change the alerting mode on the portable wireless device using a mode choice button on the portable wireless device. If the end users choice of alert mode is audible, the end user may choose songs or sounds including volume control. In the alternative, the end user may choose blinking lights or vibration modes. An LCD screen on the wireless portable device will enable the end user to identify the senders email address or addresses. The portable wireless device may also display the text of the priority email. A push button may clear any email addresses that the end user has been alerted to and wishes to delete. The portable wireless device may be recharged using a charging cradle plugged into a wall socket and or the portable wireless device may use standard batteries.

In one embodiment, a system and method is presented that enables an end-user to watch television and be alerted to priority e-mail visually or by audible alert. A transmitter/receiver is attached to a television. When priority e-mail is received an end user is alerted by a message that appears on the television screen. The message may include the senders e-mail address, along with a time and date received. The end user can choose audible alert mode, which allows the end user to be alerted by sound that a priority email has arrived. Using the receiver/transmitter the television receives a priority e-mail message. The receiver/transmitter is then used to send a message back to the receiver/transmitter connected to the computer (i.e., email server) directing the computer to stop sending messages. The user can clear the screen on the television either by changing the channel or turning the television off and then back on, etc. In one embodiment, this re-sets the priority email alert systems receiver.

In one embodiment, a system and method of notifying an end user using a cell phone or wall phone is presented. When the end users computer receives a priority e-mail, an alert message is sent to a pre-determined telephone number. The end user is alerted via the telephone network. The computer dials the pre-determined telephone number and once the end user answers the call a sound or an electronic voice alerts the end user that a priority email has arrived. An electronic voice may be used to identify the senders email address and also may be used to read the email in the electronic mail. If the end user misses the alert call, the system provides the end user the ability to call his computer and access the priority email message to hear its contents using the electronic voice. The end user will also have the ability to have the computer fax the priority email to a pre-determined fax number. If the end users computer dials the predetermined fax number and receives a busy signal, the end users computer may re-try and re-dial until the computer receives verification of a connection.

### BRIEF DESCRIPTION OF THE DRAWINGS

FIG. 1A displays a network architecture implementing the method of the present invention.

FIG. 1B displays a network architecture implementing the method of the present invention.

FIG. 2 displays a computer architecture used to implement the method of the present invention.

FIG. 3 displays a flow diagram detailing one methodology of the present invention.

FIG. 4 displays a flow diagram detailing a priority method implemented in accordance with the teachings of the present invention.

FIG. 5 displays an integrated hardware flow-chart diagram detailing a method and apparatus of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

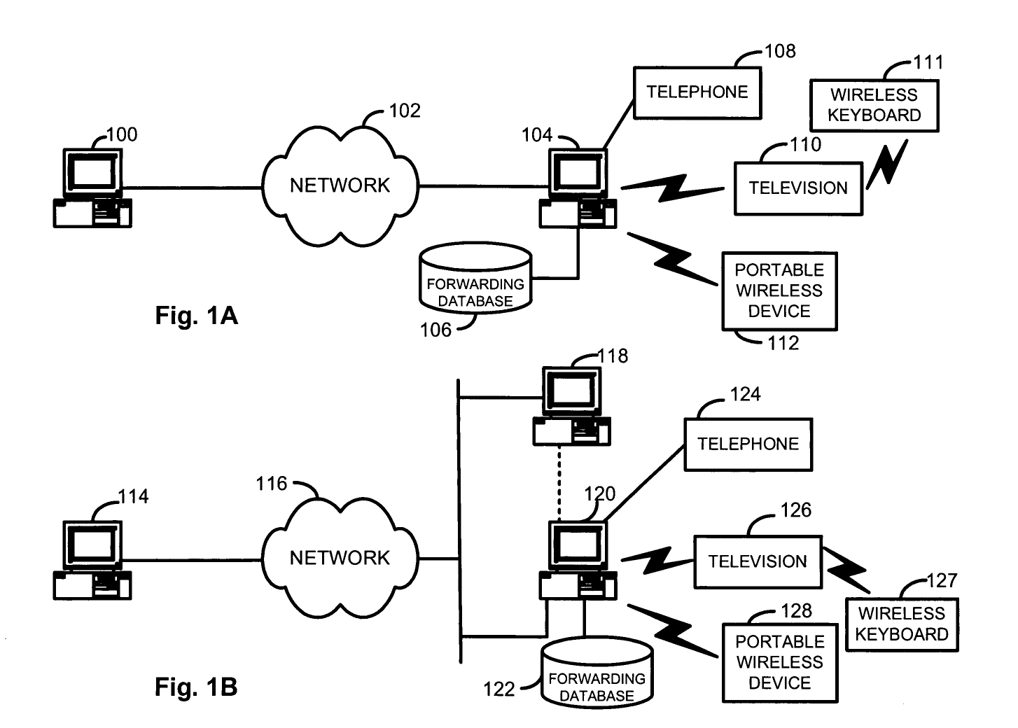

In accordance with the teachings of the present invention a priority email system is presented. FIG. 1A displays a network architecture implementing the method of the present invention. In FIG. 1A an email server 100 is shown. In one embodiment, the email server 100 may include a single computer or network of computers operated by a third party such as AT&T a Trademark of American Telephone and Telegraph or AOL a trademark of America online. Email is collected at the email server 100 and then forwarded to a client server 104 across a network 102. The email may be forwarded from the email server 100 to the client server 102 on an automated basis, when the client server 104 connects to the email server, etc. The network 102 may represent the Internet, a DSL network, a cable network, wireless network, etc. In one embodiment, the client server 104 receives the email and operates a priority method to process the email. The priority method may cause the client server 104 to check the forwarding database 106 and then forward the email on a priority bases across a landline to a telephone 108. In the alternative, the client server 104 may communicate the email through a radio frequency connection (i.e., not shown in FIG. 1A) to a television 110 or a portable wireless device 112. In one embodiment, a wireless keyboard 111 may communicate with a transmitter/receiver device or a set top box connected to a television set. As such, the wireless keyboard may be used to control the computer 104.

FIG. 1B displays a network architecture implementing the method of the present invention. In FIG. 1B a first email server 114 is shown. In one embodiment, the first email server 114 may include a single computer or network of computers operated by a third party such as AT&T a Trademark of American Telephone and Telegraph or AOL a trademark of America online. Email is collected at the first email server 114 and then forwarded to a second email server 118. In one embodiment, the second email server 118 is positioned at the end users location. For example, the second email server 118 may be implemented in a local area network. A client server 110 accesses the email from the second email server 118. In the alternative, the email may be forwarded from the second email server 118 to a client server 120 on an automated basis, when the client server 120 connects to the second email server 118, etc. The network 116 may represent the Internet, a DSL network, a cable network, wireless network, etc. In one embodiment, the client server 120 receives the email and operates a priority method to process the email. The priority method may cause the client server 120 to check a forwarding database 122 and then forward the email on a priority bases across a landline to a telephone 124. In the alternative, the client server 120 may communicate the email through a radio frequency connection (i.e., not shown in FIG. 1B) to a television 126 or a portable wireless device 128. In one embodiment, a wireless keyboard 127 may communicate with a transmitter/receiver device or a set top box connected to a television set 126. As such, the wireless keyboard may be used to control the computers 118 and 120.

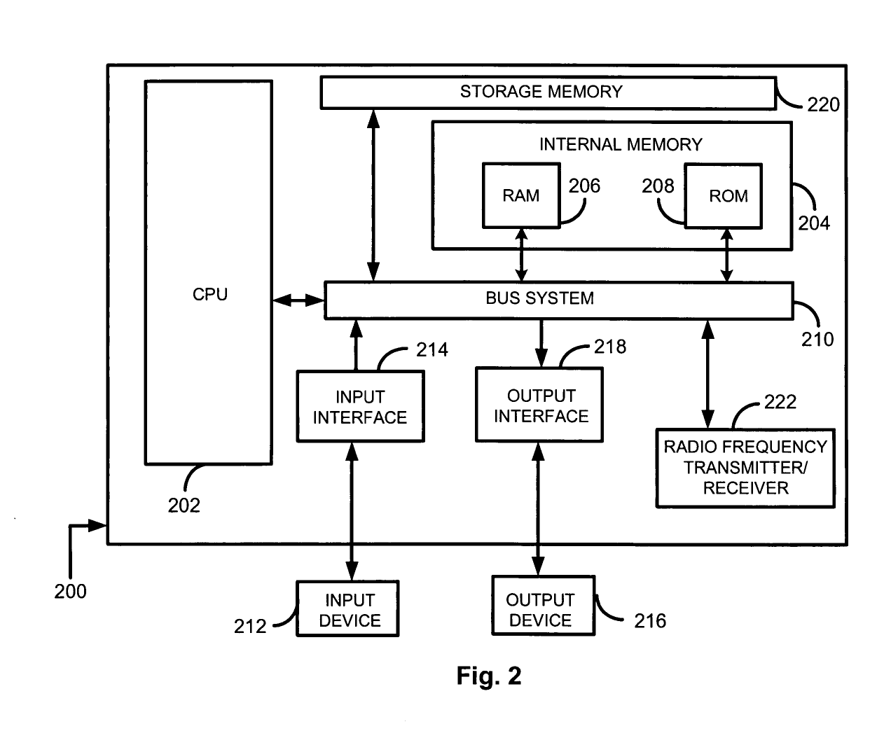

FIG. 2 displays an architecture used to implement the method of the present invention. FIG. 2 will be discussed in conjunction with FIG. 1A and FIG. 1B. In one embodiment of the present invention, the client server 104, the client server 120, the television 110, the portable wireless device 112, the television 126 and the portable wireless device 128 may be implemented with the architecture 200. However, it should be appreciated that variations on the architecture 200 may be implemented and still remain within the scope of the present invention. For example, the architecture 200 may be implemented without components such as the RAM 206 or additional components may be added to the architecture 200 and still remain within the scope of the present invention.

A central processing unit (CPU) 202 functions as the brain of the architecture 200. Internal memory 204 is shown. The internal memory 204 includes short-term memory 206 and long-term memory 208. The short-term memory 206 may be a Random Access Memory (RAM) or a memory cache used for staging information. The long-term memory 208 may be a Read Only Memory (ROM) or an alternative form of memory used for storing information. Storage memory 220 may be any memory residing within the architecture 200 other than internal memory 204. In one embodiment of the present invention, storage memory 220 is implemented with a hard drive. In one embodiment, the method of the present invention may be implemented in software stored in one of the foregoing memories (i.e., 204, 220). A bus system 210 is used to communicate information within the architecture 200. In addition, the bus system 210 may be connected to interfaces that communicate information out of the architecture 200 or receive information into the architecture 200.

Input devices, such as tactile input device, joystick, keyboard, microphone, communications connections, or a mouse, are shown as 212. The input device 212 interface with the system through an input interface 214. Output device, such as a monitor, speakers, communications connections, etc., are shown as 216. The output device 216 communicates with architecture 200 through an output interface 218.

A radio frequency transmitter/receiver 222 is implemented in the architecture 200. In one embodiment, the radio frequency transmitter/receiver 222 includes both the hardware and software required to transmit and receive information using radio frequency signals. For example, when the radio frequency transmitter/receiver is implemented in the client server (104, 120), an email may be transmitted from the television (110, 120) or from the portable wireless device (112, 128) using the radio frequency transmitter/receiver 222. In the alternative, an email may be received in the television (110, 120) or the portable wireless device (112, 128) using the radio frequency transmitter/receiver 222. In another embodiment, a priority method operates on architecture 200 and computer instructions implementing the priority method are stored in Internal memory 204 and/or storage memory 220. The computer instructions then direct the CPU 202 to operate the radio frequency transmitter/receiver 222 to transmit and receive email.

When the portable wireless device (112, 128) is implemented with the architecture 200, the radio frequency transmitter/receiver 222 may be implemented to transmit and receive email in the portable wireless device (112, 118). The output interface 218 may be used to display the email on a screen. In addition, an end user may operate a keyboard represented by input device 212 to communicate a response back through input interface 214 and out of the radio frequency transmitter/receiver 222.

When the architecture 200 is used to implement a portable wireless device (112, 128), a number of features may be implemented. For example, the portable wireless device (112, 128) may be battery operated or charged in a cradle system. The portable wireless device (112, 128) may be menu operated, as such an end user can go through the menu and apply personal settings, such as; audible/visual/vibration alert modes. An end user may also set date time settings and use the unit as an alarm clock. An end user may select alert preferences on the portable wireless device (112, 128). For example, the end user may be able to select a blinking red LED, audible alert, or vibration alert to notify an end user that a priority email has arrived.

In one embodiment, the input device 212 may be implemented using an up arrow button, a down arrow button, a delete button, and a clear button. When the input device 212 is implemented with an up arrow button, when pressed, the up arrow button will display last addresses received, along with its time, date, and priority number as received. A numeral 1 may be used to indicate the most recent email received. Simultaneous presses may display addresses from the most recent (#1) email, backwards to the latest email.

The input device 212 may be implemented with a down arrow button. When pressed, the down arrow button will display the oldest e-mail address received, along with its time, date, and priority number as received. The email addresses are then listed in order of priority. Simultaneous presses may display addresses from the latest to the most recent.

The input device 212 may be implemented with a delete button. When pressed, the delete button will cause deletion of the email that appears on the units LCD screen. An end user can browse through addresses on the unit and delete as needed. The input device 212 is implemented with as a delete button, when pressed; this will clear the alert and stop the system from the audible, vibration, or blinking LED mode.

In a third embodiment, the architecture 200 may be used to implement a television (110, 126) or a set top box connected to a television (110, 126). For example, the output device 216 may represent the television screen. As such when an email is received in the radio frequency transmitter/receiver 222, the email may be communicated across the bus system 210 and displayed on the television screen implemented with the output device 216. The email may be displayed in conjunction with the normal picture displayed on the screen or the email may be exclusively displayed. In another alternative the output device 216 may be a signaling device that alerts an end user that a priority email has arrived and is available for viewing on the television. In one embodiment, the output device may be implemented with a red L.E.D. that blinks, indicating incoming e-mail has arrived, alerting an end user even when the television is off. In another embodiment, the output device 216 may be implemented as an LCD screen that displays an e-mail address or short message.

In one embodiment, the input device 212 may be implemented as an up arrow button, a down arrow button, a delete button, or a clear button. When the input device 212 is implemented with an up arrow button, when pressed, the UP button will display last addresses received, along with its time—date—and priority number. The most recent email received may be identified with a #1. Simultaneous presses will display addresses from the most recent backwards to the latest. The LCD screen on the unit or television screen will display this information.

When the input device 212 is implemented with a down arrow button, when pressed, the down button will display the oldest email address received, along with its time—date—and priority number. The unit will remember/file 99 addresses and list them in sequential priority. Simultaneous presses will display addresses from the latest forward to the most recent.

When the input device 212 is implemented with as a delete button, when pressed, the e-mail address on the television or LCD will be deleted. End users can go through addresses and delete as needed. When the input device 212 is implemented with as a delete button, when pressed the television screen clears. In the alternative, the end user may clear the message on the screen simply by changing channels or by pushing the clear button.

In one embodiment, the architecture may represent a television and the input device 212 may represent a wireless remote in communication with the television. As such the remote may include all the capabilities that the main unit on the television may have including scrolling up or down feature and view next e-mail features. In a second embodiment, the remote may include an up arrow button, a down arrow button, a delete button, a clear button, etc performing the functions described above.

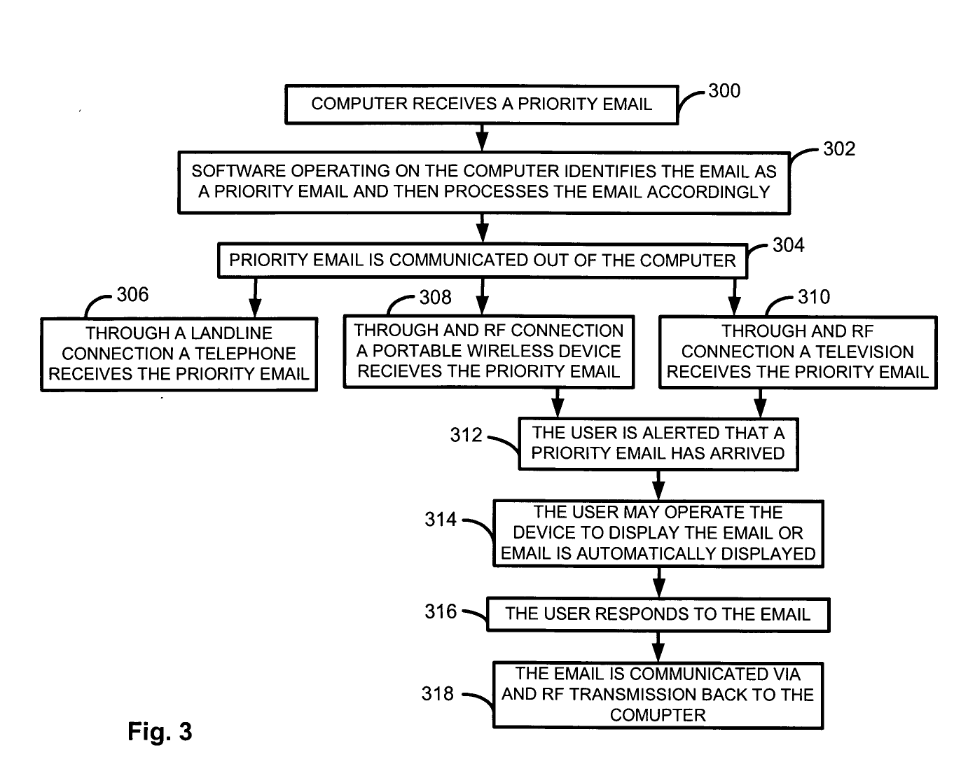

FIG. 3 displays a flow diagram detailing one methodology of the present invention. FIG. 3 will be displayed in conjunction with FIG. 1. At 300 a computer such as a client computer (104, 120) receives a priority email. At 302, a priority method operating on the computer identifies the email as a priority email and then processes the email accordingly. As step 304 the priority email is communicated out of the client computer. In one embodiment, the priority email is communicated on a landline to a telephone as stated at 306. For example, the priority method may operate to dial a predefined telephone or fax number to communicate the priority email. In another embodiment, the priority email may be communicated through an RF connection to a portable wireless device as stated at 108. At step 110, the priority email may be forwarded through an RF connection to a television. In the scenarios where the priority email is forwarded through an RF connection the receiving device (i.e., television, portable wireless device) alerts the end user that a priority email has arrived as stated at 112. This alert may occur with a blinking light, an audible sound, vibration, displaying the email across current programming, etc. At step 314, the user may operate the receiving device to display the email or the email is automatically displayed. At step 316, the user may operate the receiving device to respond to the priority email. At step 318, the email is communicated back to the client computer for further processing (i.e., storage, communication across the network, LAN, etc).

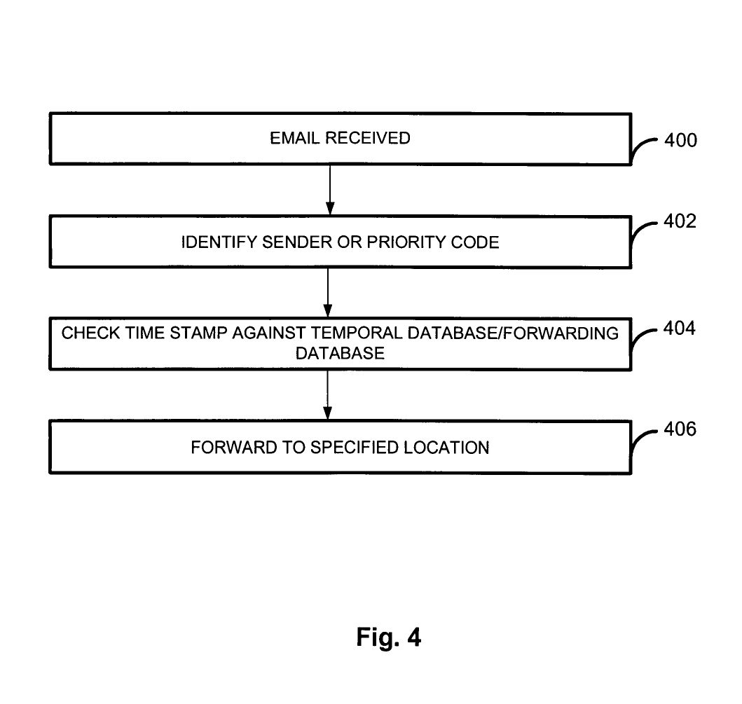

FIG. 4 displays a flow diagram detailing a priority method implemented in accordance with the teachings of the present invention. FIG. 4 will be discussed in conjunction with FIG. 1A and FIG. 1B. In one embodiment, the priority method may operate on a client server 104 or client server 120 shown in FIG. 1A and FIG. 1B, respectively. In the alternative, the priority method may operate in a distributed manner on various components in FIGS. 1A and 1B. At step 500 an email is received. For example, the email is received in the client computer 104 or 120. At 500 the email sender is identified or a priority code is identified. Based on the email sender or the priority code, the email is categorized as a priority email that requires immediate forwarding. In one embodiment, the priority email is forwarded to a predefined location. In a second embodiment, a time stamp is associated with the email and a forwarding database (i.e., 102, 122) is searched to determine the location of the end user. In one embodiment, the forwarding database may include a database table that identifies the location and device used to contact the end user at a certain time. Table I displays a sample database table:

| End User | Time | | Device | Contact number |
|---|---|---|---|---|
| John Doe | 9-11 | am | home phone | XXX-XXX-XXXX |
| John Doe | 11-3 | pm | cellular telephone | user@cellphone.com |
| John Doe | 3-8 | pm | computer email | user@computer.com |
| John Doe | 8-12 | pm | television set | RF interface address. |

Depending on the time of day the email will be transmitted to the home phone, the cellular telephone, the home computer email or the television set. At step 400 the email message is then forwarded out of the RF interface connected to the client server 104 or client server 120 or in the alternative forwarded via landline.

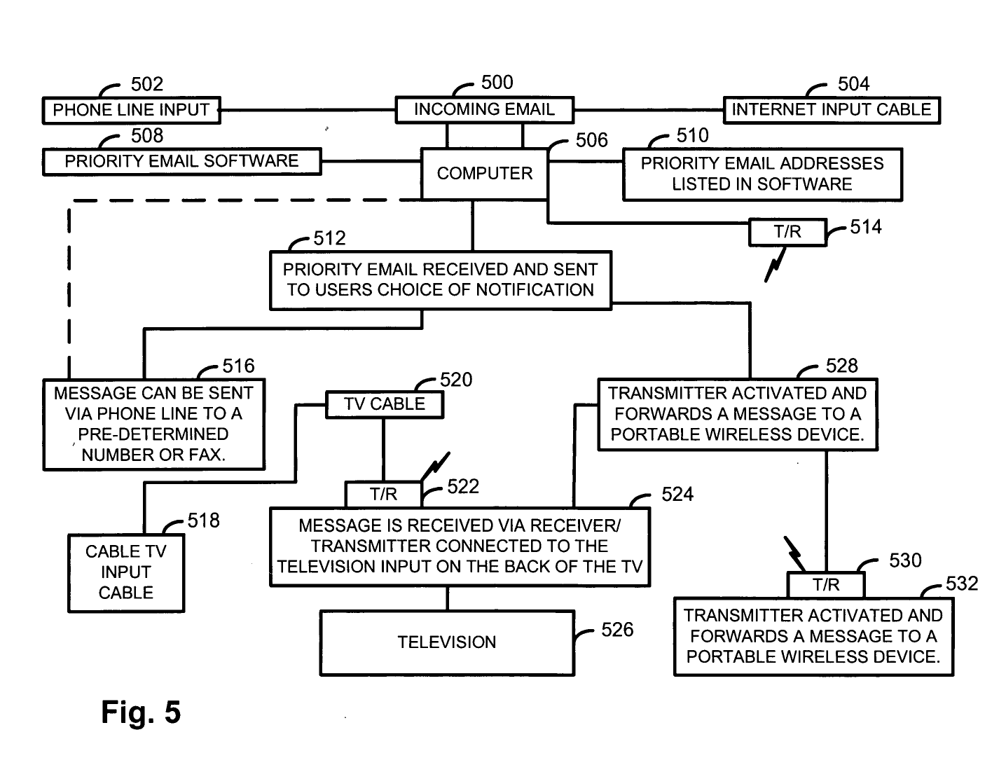

FIG. 5 displays an integrated hardware flowchart diagram detailing a method and apparatus of the present invention. At 500 an incoming email is received. The incoming email may be received from the phone line as shown at 502 or from an Internet input cable 504. In another embodiment, the incoming email may be received via a wireless connection (i.e., this would replace or be in addition to the phone line 502 or the Internet input cable 504). The computer 506 may then process the email using a priority method implemented with software as shown by 508. Priority software implementing the priority method may include priority email addresses 510, which may be matched against the email to identify the email source address and to identify the email as a priority email. The computer is connected to a radio frequency transmitter/receiver (T/R) 514. As shown at 512 the priority email is received and sent to the users choice of notification. In one embodiment, the computer 506 dials a pre-determined telephone number and a message is sent via phone line to a pre-determined number of fax as shown at 516. In another embodiment, the priority email is transmitted through the T/R 514 to a T/R 522 associated with a television. As stated at 524, the message is received by an interface integrated into the television or via the receiver transmitter 522 connected to the television input on the back of the television. In one embodiment, a cable television input cable 518 is also connected to the television cable 520. The T/R 522 upon receiving an incoming message sends a message back to the T/R 514 connected to the computer 506 acknowledging that the message was received. The priority email address may then be presented on the end users television screen. The end user visually is notified that a priority email has arrived. The television will also show the time and date that the email was received. The receiver unit may also have the ability to display a text email message. A message is then displayed on the television screen as shown at 526. The message may state “incoming priority email received” with the date and time stamp as well as the sending email address.

The unit 524 may be implemented as a set top box or other unit. As shown by 528, a transmitter (i.e., in the set top box or other unit) is activated and sends a message to a wireless portable device notifying an end user of an incoming priority email alert. The unit 524 may also forward a message back to the main transmitter/receiver plugged into the computer acknowledging receipt of the message. A portable wireless handheld device may receive information through the T/R 530. Upon receiving the incoming message the portable wireless handheld device using T/R 530 may send a message back to T/R 514 indicating that a message was received. The receiver unit associated with the portable wireless device may have an LCD screen to display an incoming email address and/or text message from the sender.

In another embodiment, a receive receiver/transmitter unit may attached to the television as an interface to a wireless keyboard. As such, an end user may use the television screen/wireless keyboard to communicate through the television unit and work off a computer located elsewhere in the house or in close proximity.

In accordance with the teachings of the present invention, the foregoing methods and apparatus may be implemented to perform a variety of inventions. In one embodiment, if a person is away from home they may use the method and apparatus of the present invention to e-mail themselves with reminders. For example, a timestamp may be associated with an email. The email may then be launched at the time. After the email is launched the email may be communicated through an RF connection associated with the computer to a wireless portable device, a television, or any of the foregoing devices provided for receiving priority emails. The device may then alert the end user.

In another application numerous priority e-mails are received simultaneously. In one embodiment, a priority code may be associated with each email and each email may be listed in priority order. In another embodiment, a round-robin alerting mechanism may be used. For example, using the first methodology, the lowest or highest priority email may be displayed on the television screen. Using the second methodology the email may be displayed in a round-robin fashion on a displaying device such as the wireless portable device, a set-top box, a television or on a television remote. The remote may be used to view/scan delete/clear/scroll the received e-mail. In one embodiment, the remote may operate like a TV remote using infrared technology.

In another application the method and apparatus may be used to alert an end user of an upcoming event/date/etc. For example, at a date in the future a computer may generate a priority email with a message of the event. In one embodiment, the user may use the computer to send priority messages (i.e., email communicated through the RF connection to the television) across a television screen to themselves. In another embodiment, these messages may be used as reminder/messages to other viewers. For example, messages such as “make that scheduled call,” “tell your wife you love her,” a reminder of a scheduled TV program, an upcoming birthday reminder, a wake up call etc. These messages will be initiated on the users computer using the method and apparatus of the present invention and can be pre-dated to be sent at any designated time, date, or year.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

It is, therefore, intended by the appended claims to cover any and all such applications, modifications, and embodiments within the scope of the present invention.

What is claimed is:

1. A method of processing priority messages comprising the steps of:
receiving an email in a computer;
identifying the email as a priority email;
transmitting via a first radio frequency interface connected to the computer;
receiving the email in an alerting device including a second radio frequency interface for receiving the email; and
alerting an end user in response to receiving the email in the alerting device.

2. A method of processing priority messages as set forth in claim 1, wherein the step of identifying the email as a priority email is performed by identifying a senders address in the email.

3. A method of processing priority messages as set forth in claim 1, wherein the step of identifying the email as a priority email is performed by identifying a priority code associated with the email.

4. A method of processing priority messages as set forth in claim 1, wherein the alerting device is a television.

5. A method of processing priority messages as set forth in claim 1, wherein the alerting device is a television remote.

6. A method of processing priority messages as set forth in claim 1, wherein the alerting device is a portable wireless device.

7. A method of processing priority messages as set forth in claim 1, wherein the step of alerting is performed by illuminating an indicator on a television.

8. A method of processing priority messages as set forth in claim 1, wherein the step of alerting is performed by displaying a message on a television.

9. A method of processing priority messages as set forth in claim 1, wherein the step of alerting is performed by displaying an email on the television.

10. A method of processing priority messages as set forth in claim 1, wherein the step of alerting is performed by generating an audible sound with the television.

11. A method of processing priority messages as set forth in claim 1, wherein the step of alerting is performed by illuminating an indicator on a portable wireless device.

12. A method of processing priority messages as set forth in claim 1, wherein the step of alerting is performed by displaying a message on a portable wireless device.

13. A method of processing priority messages as set forth in claim 1, wherein the step of alerting is performed by displaying an email on a portable wireless device.

14. A method of processing priority messages as set forth in claim 1, wherein the step of alerting is performed by displaying an email on a portable wireless device.

15. A method of processing priority messages as set forth in claim 1, wherein the step of alerting is performed by displaying an email on a television remote.

16. A method of email alerting, comprising the steps of:
receiving an email;
identifying the email as a priority email;
identifying forwarding information by referencing a forwarding database; and
forwarding the email to the to an end user in response to identifying the forwarding information, the email causing a device to alert an end user.

17. A method of email alerting as set forth in claim 16 wherein the method is performed to alert a user of an email initiated in a different time zone.

18. A method of email alerting as set forth in claim 16 wherein the method is performed to alert a user of an event.

19. A method of email alerting as set forth in claim 16 wherein the method is initiated by an end user to alert the end user.

20. A method of email alerting comprising the steps of:
receiving a priority email through a radio frequency connection to a computer, the priority email generated by the computer configured to generate the priority email at a future time; and
alerting an end user in response to receiving the priority email.
